(19) United States
(12) Patent Application Publication
(10) Pub. No.: US 2019/0116056 A1
(43) Pub. Date: Apr. 18, 2019

(54) NETWORK CONFERENCING SYSTEM, TERMINAL, RECORDING MEDIUM, AND METHOD FOR SELECTING ONE OF A PLURALITY OF CONNECTION-METHODS

(71) Applicant: Takahiro KAMEKURA, Tokyo (JP)

(72) Inventor: Takahiro KAMEKURA, Tokyo (JP)

(73) Assignee: Ricoh Company, Ltd., Tokyo (JP)

(21) Appl. No.: 16/090,414

(22) PCT Filed: Apr. 14, 2017
(86) PCT No.: PCT/JP2017/015294

§ 371 Date: Oct. 1, 2018

(30) Foreign Application Priority Data
Apr. 28, 2016 (JP) 2016-090219

(51) Int. Cl. H04L 12/18; H04L 29/06

(52) U.S. Cl. CPC H04L 12/1827; H04L 12/1818; H04L 65/403; H04L 65/1069; H04L 65/1006

(57) ABSTRACT

(Object) To reduce, in a case where a network conferencing system is compatible with multiple connection-methods, complexity of switching connection-methods to one that is compatible with a counterpart-terminal to connect with. (Means of Achieving the Object) A network conferencing system that is compatible with a plurality of connection-methods is provided. The network conferencing system includes: a module configured to receive an input indicating a destination of a call; a module configured to refer to filter-data, which is preset in a predetermined format, in order to determine whether the destination matches the filter-data; and a module configured to select one of the plurality of connection-methods, based on whether the destination matches the filter-data.

### TECHNICAL FIELD

The present disclosure relates to network conferencing systems, terminals, programs for selecting one of a plurality of communication-methods, and methods for selecting one of a plurality of communication-methods.

### BACKGROUND ART

Network conferencing systems (or online conferencing systems), which enable a chat function for sending/receiving messages, a file sending/receiving function, and an audio/video conferencing function, have been in general use through networks. For example, there are network conferencing systems such as “Lync”, “Skype” and “Skype for Business” provided by Microsoft Corporation, and “Sametime” provided by International Business Machines Corporation.

Connection formats of such a network conferencing system are broadly divided into two formats: a conference through a peer-to-peer (P2P) connection (hereinafter abbreviated as a “P2P conference”); and a conference through a client/server (C/S) model connection (hereinafter abbreviated as a “C/S conference”). In a P2P conference, client-terminals of users are connected through a P2P connection, to transmit and receive content data (e.g. a text, audio/video, etc.). Note that, even in a P2P conference, there is a mediating server when connecting terminals. In a C/S conference, client-terminals transmit and receive content data through a server.

There are network conferencing systems that are compatible with such two connection-methods but basically do not allow users to have a P2P conference and only allow users to have a C/S conference. A reason is, for example, that necessary information such as a call-log is not stored in some P2P conferences because of no mediation of a server once connected; or that P2P conferences may inherently involve defects.

According to a method disclosed in PTL 1, an identifier for identifying a conference to join is generated, and a conference resource is identified by decoding the identifier, for a purpose of decreasing a risk of vulnerability to crashes and delays due to equipment failure in a distributed conferencing system.

### CITATION LIST

### Patent Literature

[PTL 1] Japanese Translation of PCT International Application Publication No. JP-T-2012-519417

### SUMMARY OF INVENTION

### Technical Problem

With respect to such above-described systems that are compatible with the two connection-methods but basically allow users to have a C/S conference only, there has been a problem that, in a case where a counterpart-terminal to be connected with requires a P2P connection, terminals cannot be successfully connected without a preceding process of switching the connection-methods from a C/S connection to a P2P connection. That is to say, with respect to network conferencing systems provided on the Internet that are assumed to connect terminals through a P2P connection, a terminal cannot be successfully connected to such systems through a C/S connection, and therefore the terminal is required to connect through a P2P connection.

In systems that basically allow users to have a C/S conference only, it is necessary to switch the connection-methods to a P2P connection or to a C/S connection, depending on whether a counterpart-terminal requires a P2P connection. However, a user has to perform a bothersome process: consciously selecting a P2P connection or a C/S connection. Furthermore, in a case where a call directed to an address was made but resulted in a connection error, a user may not be aware that the error is caused by difference of connection-methods. In such a case, it is inherently difficult for the user to perform a process to switch the connection-methods and then try to connect again. Note that, in the above prior literature, there is no reference directed to a solution to such a problem.

The present invention is provided in view of such a conventional problem as described above; the object of the present invention is to reduce complexity of switching connection-methods to one that is compatible with a counterpart-terminal to connect with, in a network conferencing system that is compatible with multiple connection-methods.

### Solution to Problem

One aspect of the present invention provides a network conferencing system that is compatible with a plurality of connection-methods. The network conferencing system includes: a module configured to receive an input indicating a destination of a call; a module configured to refer to filter-data, which is preset in a predetermined format, in order to determine whether the destination matches the filter-data; and a module configured to select one of the plurality of connection-methods, based on whether the destination matches the filter-data.

### Advantageous Effects of Invention

According to the present invention, in a network conferencing system that is compatible with multiple connection-methods, complexity of switching connection-methods to one that is compatible with a counterpart-terminal to connect with can be reduced.

### BRIEF DESCRIPTION OF DRAWINGS

FIG. 1 is a drawing illustrating an example of a configuration of a system according to an embodiment of the present invention;

FIG. 2 is a drawing illustrating an example of a functional configuration of a conferencing system server, according to the embodiment of the present invention;

FIG. 3 is a drawing illustrating an example of a functional configuration of a client, according to the embodiment of the present invention;

FIG. 4A is a drawing illustrating an example of filter-data, according to the embodiment of the present invention;

FIG. 4B is a drawing illustrating an example of filter-data, according to the embodiment of the present invention;

FIG. 4C is a drawing illustrating an example of filter-data, according to the embodiment of the present invention;

FIG. 4D is a drawing illustrating an example of filter-data, according to the embodiment of the present invention;

FIG. 5 is a drawing illustrating an example of a hardware configuration of the conferencing system server and a client, according to the embodiment of the present invention;

FIG. 6 is a drawing illustrating an example of signing-in to the conferencing system server, according to the embodiment of the present invention;

FIG. 7 is a flowchart illustrating an example of processing performed by a client, according to the embodiment of the present invention;

FIG. 8 is a first drawing illustrating an example of matching to conditions, according to the embodiment of the present invention;

FIG. 9 is a second drawing illustrating an example of matching to conditions, according to the embodiment of the present invention;

FIG. 10 is a third drawing illustrating an example of matching to conditions, according to the embodiment of the present invention;

FIG. 11 is a fourth drawing illustrating an example of matching to conditions, according to the embodiment of the present invention;

FIG. 12 is a drawing illustrating an example of processing performed at a time of conducting a P2P conference by means of the conferencing system server;

FIG. 13 is a drawing illustrating an example of processing performed at a time of conducting a C/S conference by means of the conferencing system server, according to the embodiment of the present invention;

FIG. 14 is a drawing illustrating an example of processing performed at a time of making a call via the conferencing system server, according to the embodiment of the present invention;

FIG. 15 is a drawing illustrating an example of processing performed at a time of connecting to an external internet conferencing system through a P2P connection, according to the embodiment of the present invention;

FIG. 16 is a first flowchart illustrating an example of processing of updating filter-data, according to the embodiment of the present invention; and

FIG. 17 is a second flowchart illustrating an example of processing of updating filter-data, according to the embodiment of the present invention.

### DESCRIPTION OF EMBODIMENTS

The following description explains a preferable embodiment of the present invention.

<Configuration>

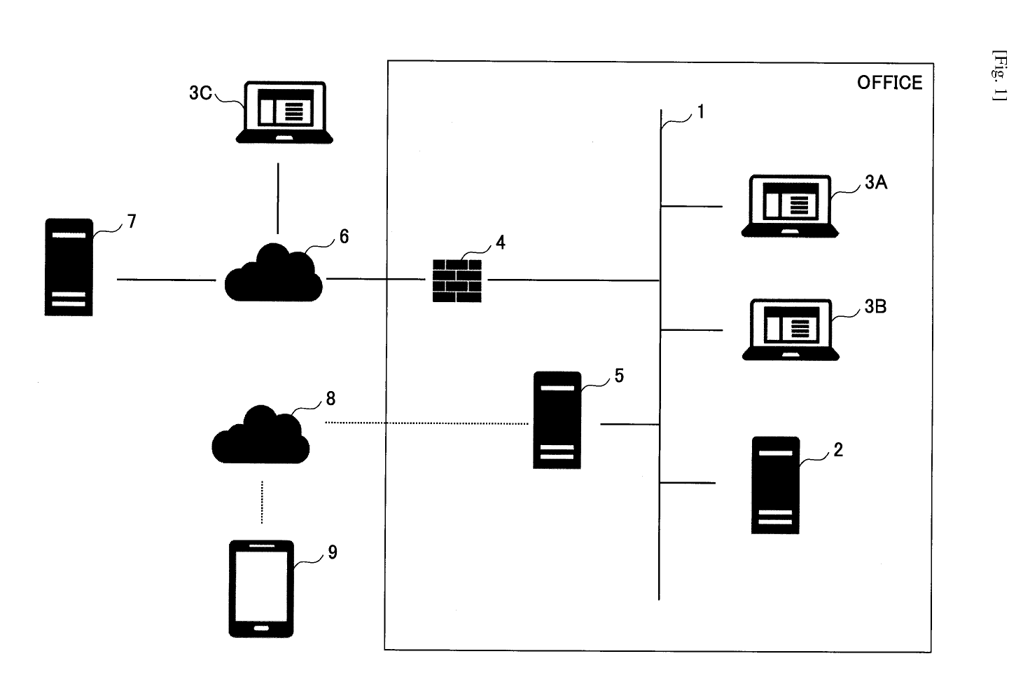

FIG. 1 is a drawing illustrating an example of a configuration of a system according to the embodiment of the present invention. In FIG. 1, a conferencing system server 2, clients 3A and 3B, a firewall (FW) 4, a Voice over Internet Protocol (VoIP) gateway 5 are connected to an intranet 1 at an office, which may be wired or wireless. The conferencing system server 2 is an information processing apparatus that manages and in-termediates a P2P conference, a C/S conference, a VoIP call, etc. The clients 3A and 3B are information terminals such as personal computers (PCs) of users, which are capable of signing-in to the conferencing system server 2, to utilize functions provided by the conferencing system server 2 such as a P2P conference, a C/S conference, a VoIP call, etc. Each of the clients 3A and 3B has an ID in the Session Initiation Protocol-Uniform Resource Identifier (SIP-URI) scheme (cf. RFC3261), which is utilized for calling counterpart-terminals. The FW 4 is an information processing apparatus connecting external Internet 6 and the intranet 1, which protects the internal network of the office from an unauthorized access hacking-in via the Internet 6. The VoIP gateway 5 is an information processing apparatus that connects a Public Switched Telephone Networks (PSTN) 8 and the intranet 1.

Furthermore, a client 3C and an external internet conferencing system 7 are connected to the Internet 6. The client 3C is an information terminal such as a PC of a user out of the office, which is capable of accessing the conferencing system server 2 and the external internet conferencing system 7 for conferencing functions. The external internet conferencing system 7 is a web-based network conferencing system provided on the Internet 6, such as WebEx provided by Cisco Systems, Inc. Furthermore, a phone 9 such as a smartphone is connected to the PSTN 8.

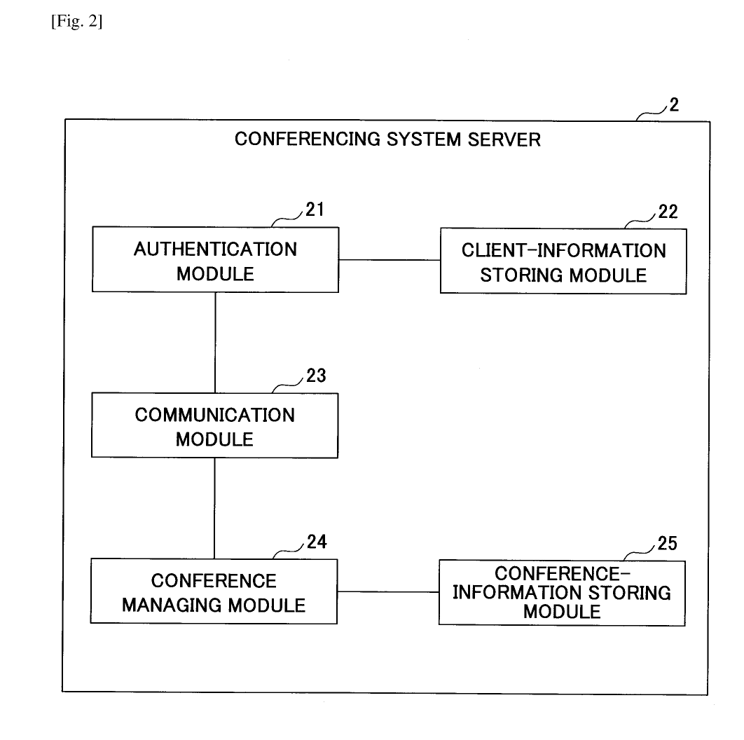

FIG. 2 is a drawing illustrating an example of a functional configuration of the conferencing system server 2. In FIG. 2, the conferencing system server 2 includes an authentication module 21, a client-information storing module 22, a communication module 23, a conference managing module 24, and a conference-information storing module 25. The authentication module 21 performs authentication processing, responding to an authentication-request transmitted from a client 3 (3A, 3B, 3C, . . . ). The authentication module 21 determines whether to authenticate, based on comparison of authentication-information (e.g. a SIP-URI, a password, etc.) transmitted from a client 3 and client-information stored in the client-information storing module 22. The client-information storing module 22 stores client-information (e.g. a SIP-URI, a password, etc.) for performing authentication of a client 3 and stores an Internet Protocol (IP) address, etc., of a signed-in client 3.

The communication module 23 performs network communication; the communication module 23 transmits and receives a command, video/audio data, etc., among a client 3, the VoIP gateway 5, the external internet conferencing system 7, and the phone 9, via the intranet 1 and the Internet 6. The conference managing module 24 performs control of starting a conference, transmitting/receiving a command and forwarding video/audio data during a conference, etc. The conference-information storing module 25 stores a conference ID, client-information of a client participating in a conference, etc.

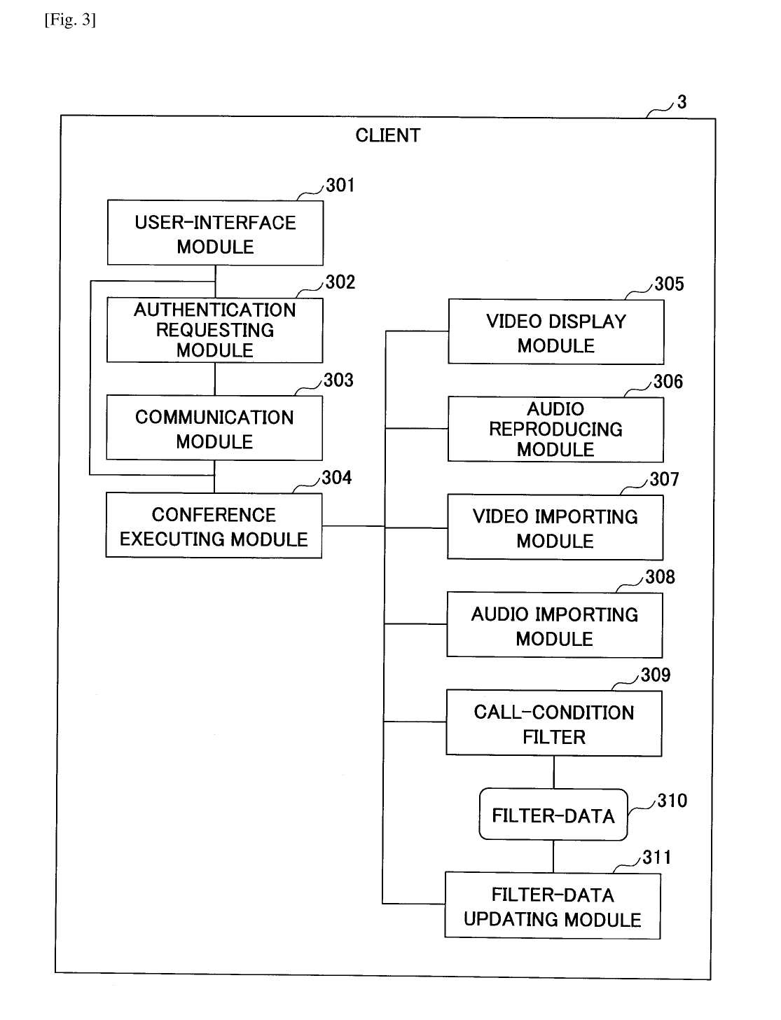

FIG. 3 is a drawing illustrating an example of a functional configuration of a client 3. In FIG. 3, the client 3 includes a user-interface module 301, an authentication requesting module (or authentication obtaining module) 302, a communication module 303, and a conference executing module 304. Furthermore, the client 3 includes a video display module 305, an audio reproducing module 306, a video importing module 307, an audio importing module 308, a call-condition filter 309, a filter-data 310, and a filter-data updating module 311. The user-interface module 301 receives an input from a user of the client 3 such as an input of a URI or a password of a call-destination (i.e. a destination) and an instruction for starting a call. The authentication requesting module 302 transmits an authentication-request to the conferencing system server 2; the authentication requesting module 302 transmits an authentication-request to the conferencing system server 2 via the communication module 303 along with a URI or a password, which is input through the user-interface module 301.

The communication module 303 performs network communication; the communication module 303 transmits and receives a command, video/audio data, etc., among the conferencing system server 2, the external internet conferencing system 7, and other clients 3 via the intranet 1 and the Internet 6. The conference executing module 304 performs control of executing a conference; the conference executing module 304 performs control of transmitting/receiving a command, video/audio data, etc., to/from the conferencing system server 2 and other clients 3, based on a command transmitted/received through the communication module 303.

The video display module 305 displays video for a user, based on video data received through the conference executing module 304. The audio reproducing module 306 re-produces audio data received through the conference executing module 304 for a user. The video importing module 307 imports video captured by a camera of a client 3 (i.e. a subject-client), and the imported video data is transmitted to other clients 3 or the conferencing system server 2 through the conference executing module 304. The audio importing module 308 imports audio collected by a microphone of a client 3 (i.e. a subject-client), and the imported audio data is transmitted to other clients 3 or the conferencing system server 2 through the conference executing module 304.

The call-condition filter 309 selects a call-condition such as a connection-method; the call-condition filter 309 selects whether to connect to a counterpart-terminal of a call-destination through a P2P connection or through a C/S connection, based on call-destinations represented by the filter-data 310. A call to start a conference is made by the conference executing module 304, in accordance with the selected connection-method. The filter-data 310 includes data of a call-destination to be utilized for decision of a call-condition, which is performed through matching based on a predetermined matching-method (e.g. a front-match method, an exact-match method, or a method by use of a regular expression, etc.) and connection-method of matched-case (e.g. a P2P connection, a C/S connection, etc.). Note that designation of a matching-method and a connection-method of matched-case may be performed based on a program in a fixed manner or may be performed based on data included in the filter-data 310 (e.g. based on specific data included in the filter-data 310, based on dis-tinguished file names or folder names, etc).

The filter-data updating module 311 automatically updates the filter-data 310. For example, the filter-data updating module 311 acquires filter-data from a preset client 3 (i.e. a parent-client) at a predetermined timing, and then reflects the filter-data in the filter-data 310 of the client 3 (i.e. the subject-client). Further, the filter-data updating module 311 acquires data representing a destination, to which connecting has been attempted by means of the conference executing module 304, as well as data representing a corresponding connection-method and connection-result, and then updates the filter-data 310 of the client 3 (i.e. the subject-client), in accordance with the data representing the destination, the connection-method and the connection-result.

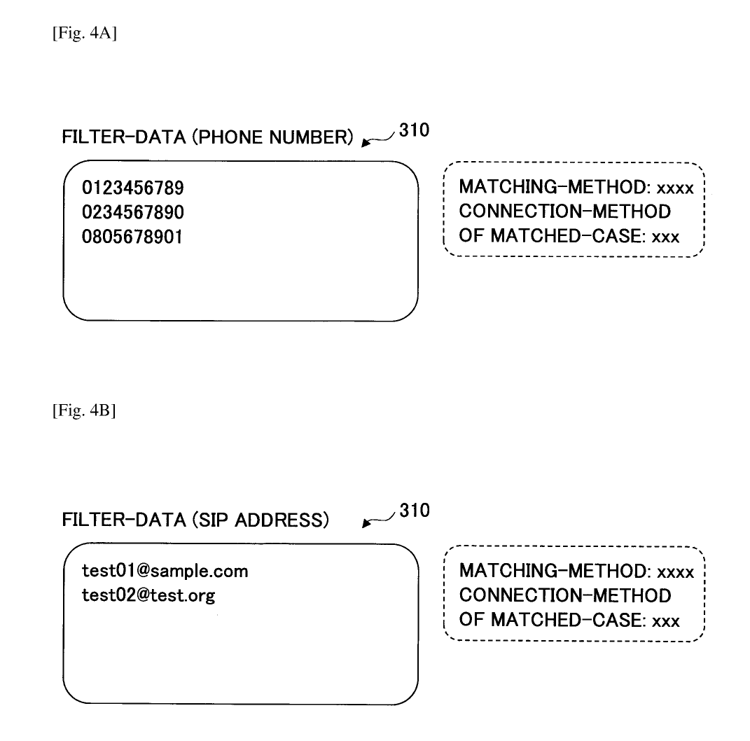

FIGS. 4A through 4D are drawings illustrating examples of the filter-data 310. In FIG. 4A, phone numbers of call-destinations are listed. In FIG. 4B, SIP addresses of call-destinations are listed. In FIG. 4C, regular expressions expressing SIP addresses of call-destinations are listed. In FIG. 4D, SIP domains of call-destinations are listed. Matching to the listed call-destinations is performed in a selected matching-method (e.g. a front-match method, an exact-match method, a method by use of a regular expression, etc.). In a case of confirming that call-destinations are matched, a connection-method is selected in accordance with a predetermined connection-method of matched-case (e.g. a P2P connection, a C/S connection, etc.).

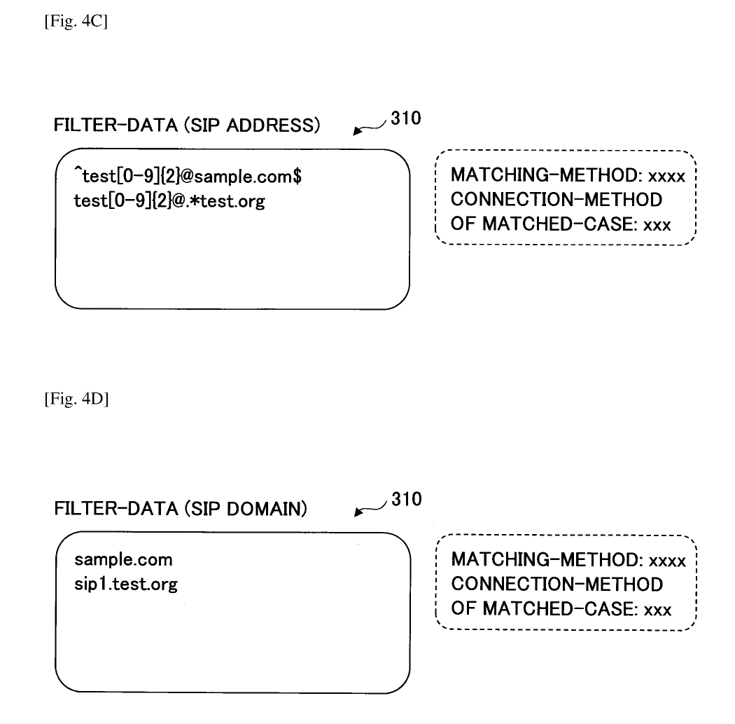

FIG. 5 is a drawing illustrating an example of a hardware configuration of the conferencing system server 2 and a client 3. In FIG. 5, the conferencing system server 2 and the client 3 include a central processing unit (CPU) 201, a read only memory (ROM) 202, and a random access memory (RAM) 203, which are interconnected via a bus 207. Furthermore, the conferencing system server 2 and the client 3 include a hard disk drive/solid state drive (HDD/SSD) 204, a connection interface (I/F) 205, and a communication I/F 206. The CPU 201 executes programs stored in the ROM 202, the HDD/SSD 204, etc., by use of the RAM 203 as a work area, so as to comprehensively control operation of the conferencing system server 2 and the client 3. The connection I/F 205 is an interface to devices connected to the conferencing system server 2 and the client 3, respectively. The communication I/F 206 is an interface provided for performing communication with other information processing apparatuses via a network.

Functions of each device explained along with FIG. 2 and FIG. 3 are actualized by the CPU 201 executing predetermined programs. Programs may be acquired via a recording medium or via a network, and may be stored in the ROM 202. Data referred to or updated in processing is stored in the RAM 203 or the HDD/SSD 204. Various types of information (data) explained along with FIG. 2 and FIG. 3 are temporarily stored in the RAM 203 and persistently stored in the HDD/SSD 204.

<Operation>

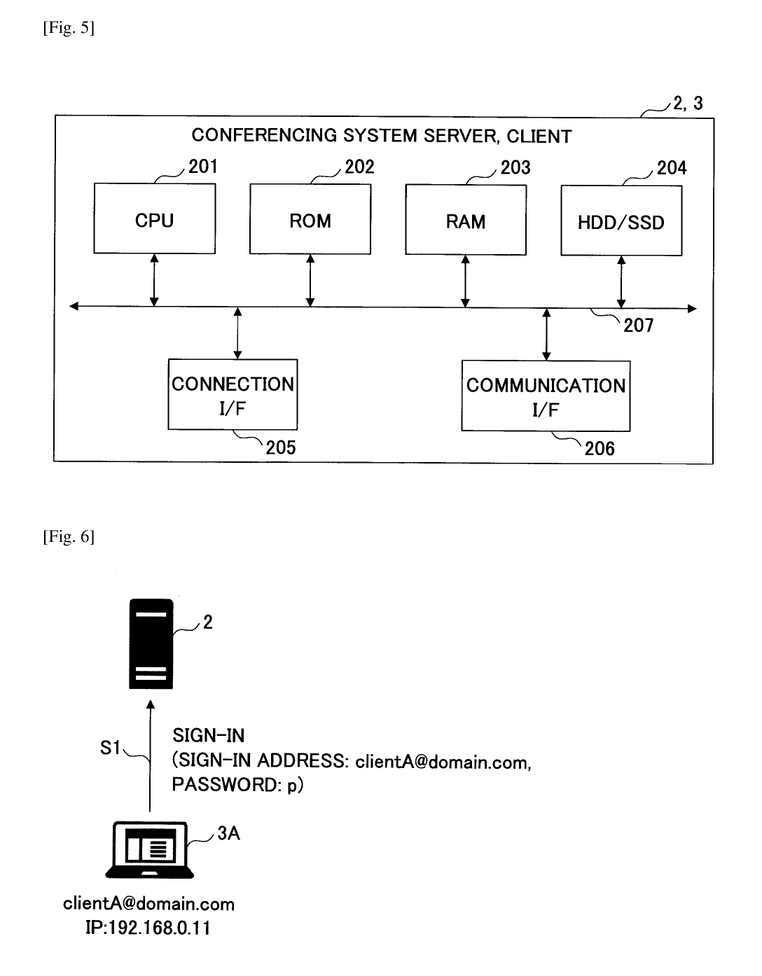

A user of a client 3 is required to sign-in (or log-in) to the conferencing system server 2, to utilize the conferencing system server 2. FIG. 6 is a drawing illustrating an example of signing-in to the conferencing system server 2.

In FIG. 6, the client 3A transmits its own authentication-information (e.g. a sign-in address, a password, etc.) to the conferencing system server 2, to request for authentication (Step S1). The conferencing system server 2 performs authentication in a case of confirming that the authentication-information matches registered information. Thus, the conferencing system server 2 is able to acquire information that the client 3A has been signed-in and to acquire the IP address of the client 3A.

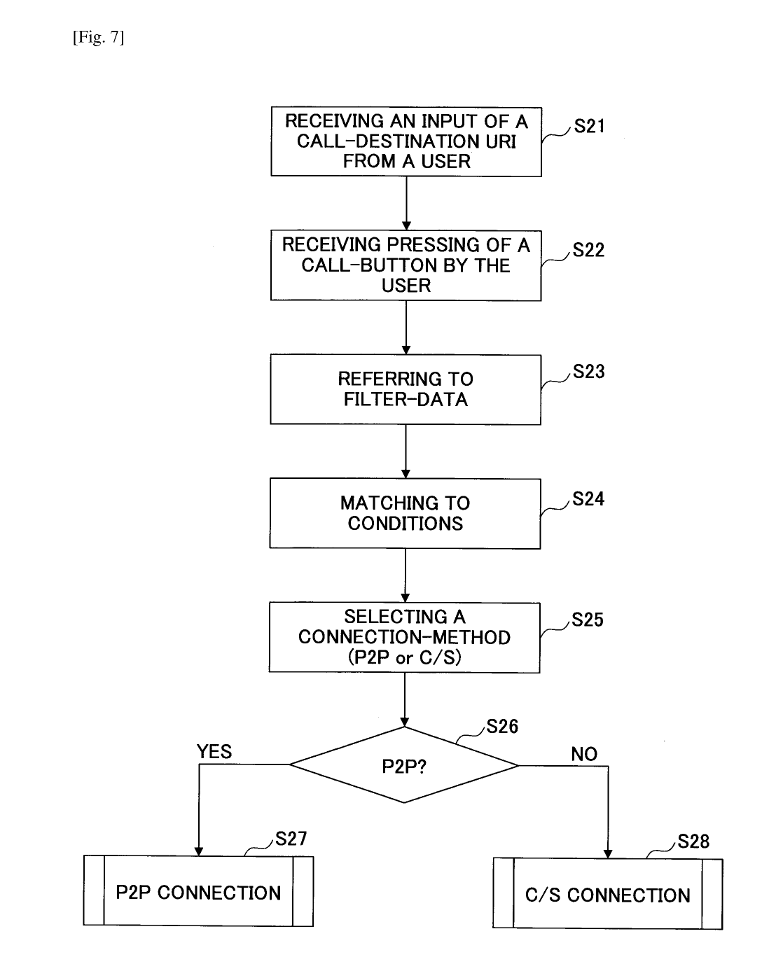

FIG. 7 is a flowchart illustrating an example of processing performed by a client 3. In FIG. 7, the user-interface module 301 of the client 3 receives an input of a call-destination URI from a user (Step S21), then receives pressing of a call-button by the user (Step S22), and then transmits the call-destination URI to the conference executing module 304.

By means of the call-condition filter 309, the conference executing module 304 refers to the filter-data 310 (Step S23), and then performs matching to conditions (Step S24). The conference executing module 304 selects a connection-method (i.e. a P2P connection or a C/S connection), based on a matching-result (Step S25). Then, in a case where a P2P connection is selected as the connection-method (Yes at Step S26), the conference executing module 304 makes a call to the conferencing system server 2 through a P2P connection (Step S27). Furthermore, in a case where a P2P connection is not selected as the connection-method (No at Step S26), the conference executing module 304 makes a call to the conferencing system server 2 through a C/S connection (Step S28).

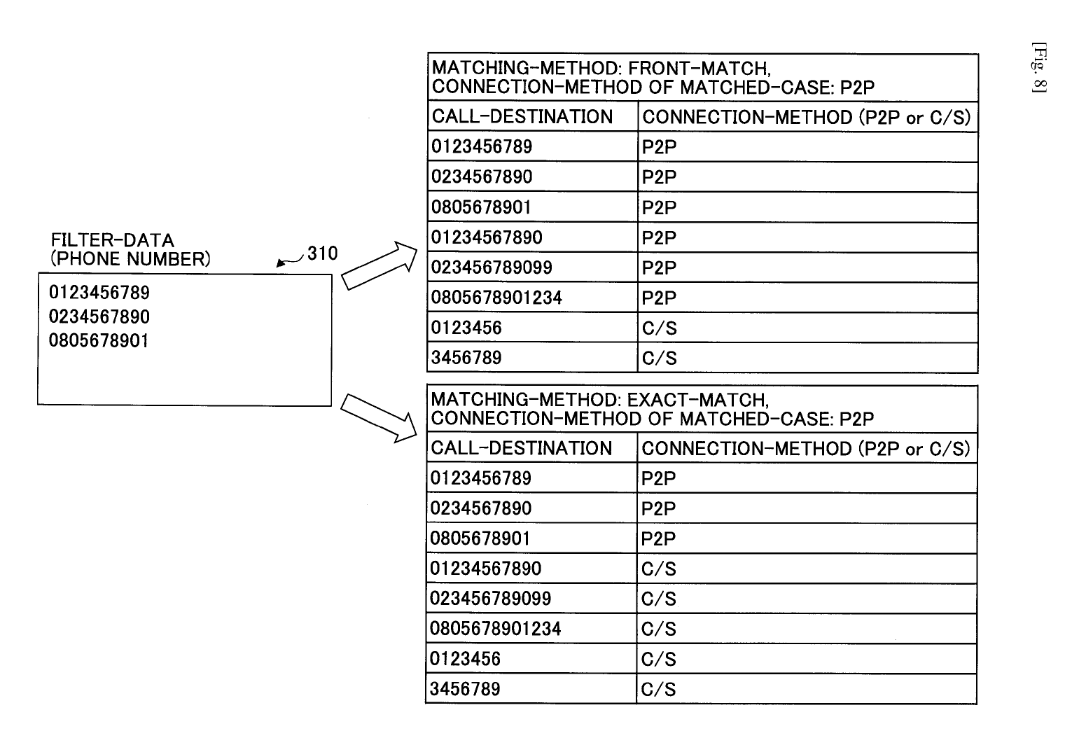

FIGS. 8 through 11 are drawings illustrating examples of matching to conditions, based on the call-condition filter 309 and the filter-data 310 corresponding to the filter-data 310 as illustrated in FIGS. 4A through 4D, respectively.

In the filter-data 310 of FIG. 8, a P2P connection is selected as the connection-method of matched-case, and phone numbers of call-destinations for a P2P conference are listed. In a case where a front-match method is set as the matching-method, connection-methods of call-destinations are selected as illustrated on the upper right. That is to say, in a case of inputting the call-destinations “0123456789”, “0234567890”, and “0805678901”, which are exactly as listed in the filter-data 310, P2P connections are selected as the connection-methods because the call-destinations match conditions. Furthermore, because the front-match method is set as the matching-method, call-destinations “01234567890”, “023456789099”, and “0805678901234” also match the conditions, and therefore P2P connections are selected as the connection-methods. However, call-destinations “0123456” and “3456789” do not match the conditions, and therefore C/S connections are selected as the connection-methods.

Furthermore, in a case where an exact-match method is set as the matching-method, connection-methods of call-destinations are selected as illustrated on the lower right. That is to say, in a case of inputting the call-destinations “0123456789”, “0234567890”, and “0805678901”, which are exactly as listed in the filter-data 310, P2P connections are selected as the connection-methods because the call-destinations match the conditions. However, because the exact-match method is set as the matching-method, the call-destinations “01234567890”, “023456789099”, and “0805678901234” do not match the conditions, and therefore C/S connections are selected as the connection-methods. Furthermore, call-destinations “0123456” and “3456789” do not match the conditions, and therefore C/S connections are selected as the connection-methods.

Note that, in the above example, although the connection-method of matched-case is a P2P connection, whereby a P2P connection is selected as a connection-method in a case of matching the condition and a C/S connection is selected as a connection-method in a case of not matching the condition, the connection-method of matched-case may also be a C/S connection, whereby a C/S connection is selected as a connection-method in a case of matching the condition and a P2P connection is selected as a connection-method in a case of not matching the condition.

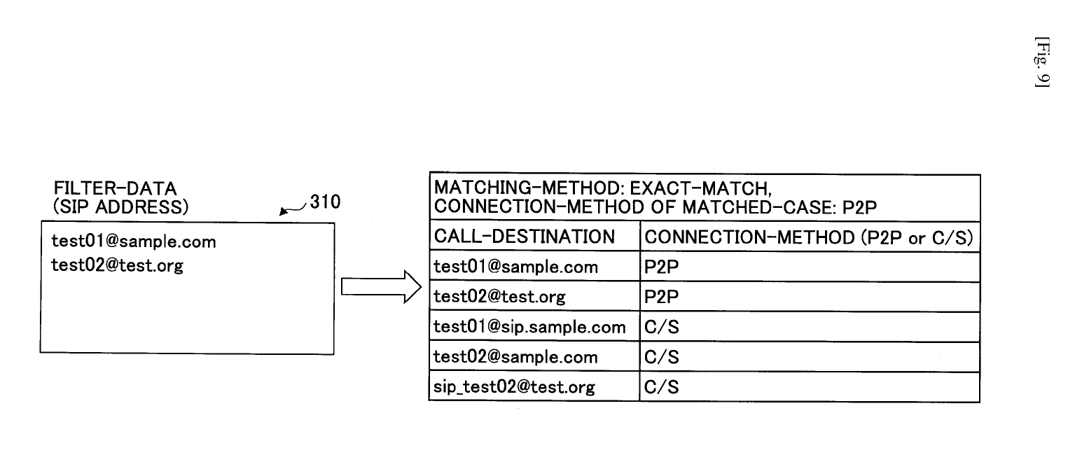

In the filter-data 310 of FIG. 9, a P2P connection is selected as the connection-method of matched-case, and SIP addresses of call-destinations for a P2P conference are listed. In a case where an exact-match method is set as the matching-method, connection-methods of call-destinations are selected as illustrated on the right. That is to say, in a case of inputting the call-destinations “test01@sample.com” and “test02@test.org”, which are exactly as listed in the filter-data 310, P2P connections are selected as the connection-methods because the call-destinations match conditions. However, because the exact-match method is set as the matching-method, call-destinations “test01@sip.sample.com”, “test02@sample.com”, and “sip_test02@test.org” do not match the conditions, and therefore C/S connections are selected as the connection-methods.

Note that, in the above example, although the connection-method of matched-case is a P2P connection, whereby a P2P connection is selected as a connection-method in a case of matching the condition and a C/S connection is selected as a connection-method in a case of not matching the condition, the connection-method of matched-case may also be a C/S connection, similarly to the case of phone numbers, whereby a C/S connection is selected as a connection-method in a case of matching the condition and a P2P connection is selected as a connection-method in a case of not matching the condition. Furthermore, similarly to the case of phone numbers, a front-match method may be technically selected as the matching-method, although a specific example is not provided here because there is little sense in selecting a front-match method as the matching-method in the case of SIP addresses.

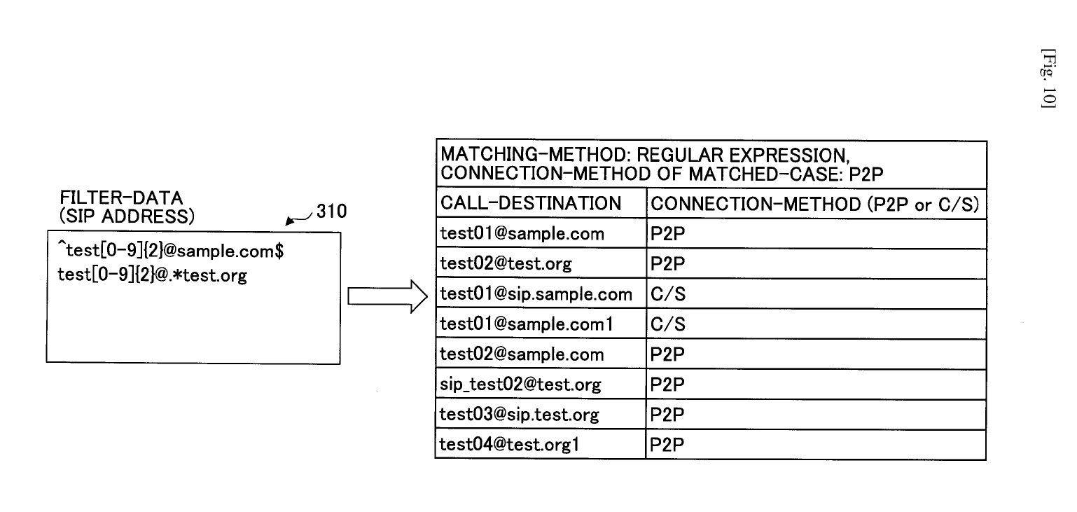

In the filter-data 310 of FIG. 10, a P2P connection may be selected as the connection-method of matched-case, and regular expressions expressing SIP addresses of call-destinations for a P2P conference are listed. In the illustrated case, connection-methods of call-destinations are selected as illustrated on the right. That is to say, in a case of inputting call-destinations “test01@sample.com” and “test02@test.org”, P2P connections are selected as the connection-methods because the call-destinations match conditions. Further, call-destinations “test02@sample.com”, “sip_test02@test.org”, “test03@sip.test.org”, and “test04@test.org1” match the conditions, and therefore P2P connections are selected as the connection-methods. However, call-destinations “test01@sip.sample.com” and “test01@sample.com1” do not match the conditions, and therefore C/S connections are selected as the connection-methods.

Note that, in the above example, although the connection-method of matched-case is a P2P connection, whereby a P2P connection is selected as a connection-method in a case of matching the condition and a C/S connection is selected as a connection-method in a case of not matching the condition, the connection-method of matched-case may also be a C/S connection, similarly to the case of phone numbers, whereby a C/S connection is selected as a connection-method in a case of matching the condition and a P2P connection is selected as a connection-method in a case of not matching the condition.

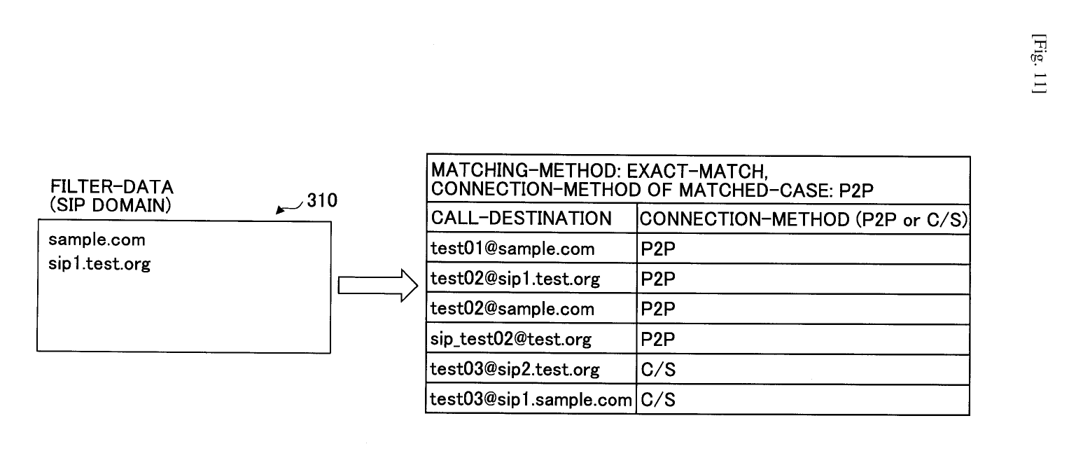

In the filter-data 310 of FIG. 11, a P2P connection is selected as the connection-method of matched-case, and SIP domains of call-destinations for a P2P conference are listed. In a case where an exact-match method is set as the matching-method, connection-methods of call-destinations are selected as illustrated on the right. That is to say, P2P connections are selected as connection-methods of call-destinations “test01@sample.com”, “test02@sip1.test.org”, “test02@sample.com”, and “sip_test02@test.org” because domains of the call-destinations exactly match the conditions defined in the filter-data 310. However, domains of call-destinations “test03@sip2.test.org” and “test03@sip1.sample.com” do not match the conditions, and therefore C/S connections are selected as the connection-methods.

The following description explains processing performed after either a P2P connection or a C/S connection is selected as a communication-method in the above processing.

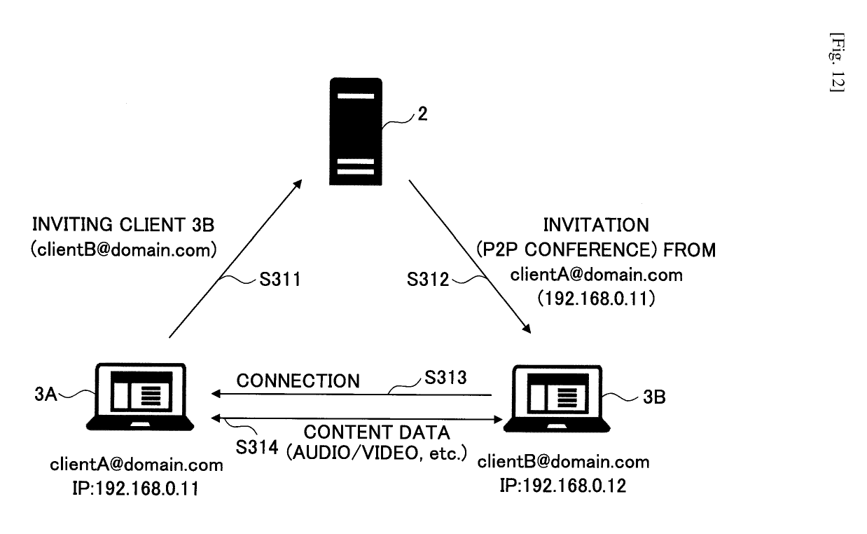

FIG. 12 is a drawing illustrating an example of processing performed at a time of conducting a P2P conference by means of the conferencing system server 2, where a P2P connection has been selected as the connection-method. Note that, the clients 3A and 3B are assumed to have signed-in to the conferencing system server 2.

In FIG. 12, the client 3A requests the conferencing system server 2 to invite the client 3B (Step S311).

Responding to the request, the conferencing system server 2 informs the client 3B of the invitation from the client 3A (Step S312).

Responding to the information, the client 3B connects to the client 3A (Step S313), and then the client 3A and the client 3B transmit/receive content data with each other (Step S314) to conduct a conference.

Through the above processing, the client 3A and the client 3B can conduct a conference through a P2P connection.

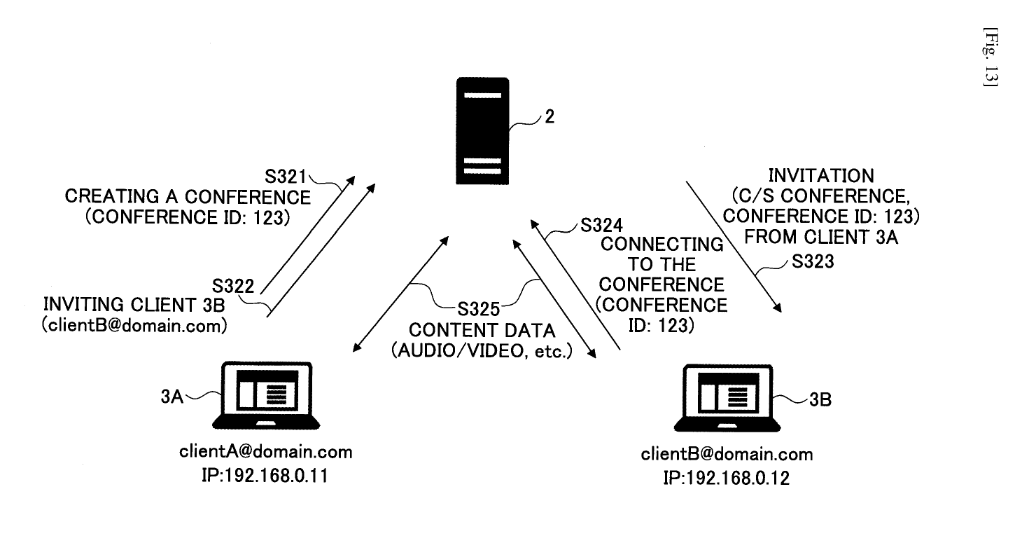

FIG. 13 is a drawing illustrating an example of processing performed at a time of conducting a C/S conference by means of the conferencing system server 2, where a C/S connection has been selected as the connection-method. Note that, the clients 3A and 3B are assumed to have signed-in to the conferencing system server 2.

In FIG. 13, first, the client 3A creates a conference (e.g. CONFERENCE ID: 123) on the conferencing system server 2 (Step S321).

Next, the client 3A invites the client 3B to the created conference (i.e. CONFERENCE ID: 123) (Step S322).

Responding to the invitation, the conferencing system server 2 informs the client 3B of the invitation from the client 3A to the conference (i.e. CONFERENCE ID: 123) (Step S323).

Responding to the information, the client 3B joins the conference (i.e. CONFERENCE ID: 123) (Step S324), and then the client 3A and the client 3B transmit/receive content data with each other (Step S325), to have the conference.

Through the above processing, the client 3A and the client 3B can conduct a C/S conference through a connection via the conferencing system server 2. Furthermore, in a case of a C/S conference, a multi-participant conference, which is not possible in a case of a P2P connection, may be held when another client performs the same connecting flow in the above-described situation.

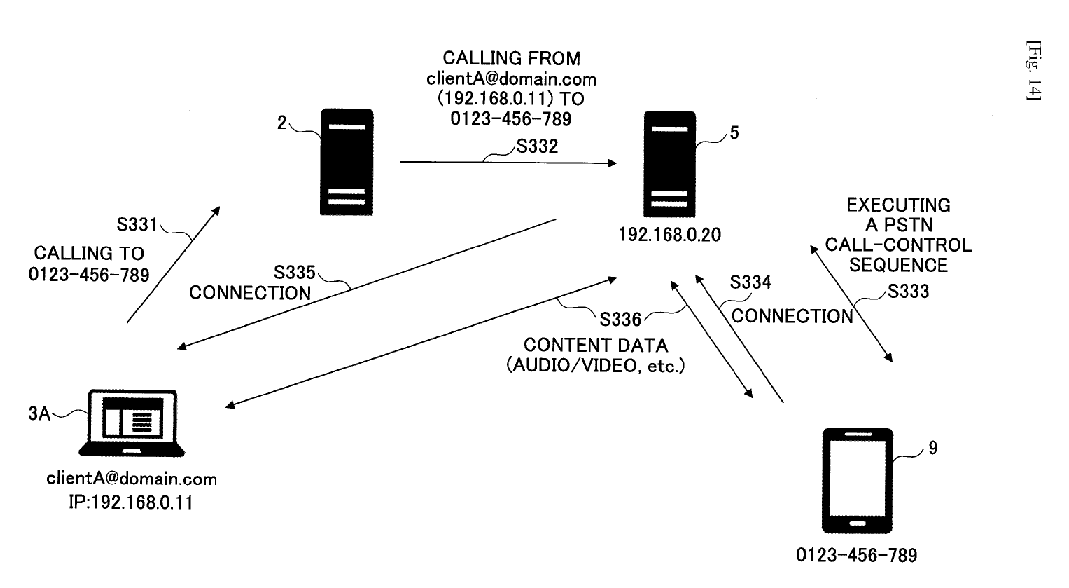

FIG. 14 is a drawing illustrating an example of processing performed at a time of making a call via the conferencing system server 2, where a P2P connection has been selected as the connection-method. In FIG. 14, first, the client 3A requests the conferencing system server 2 to make a call to the phone 9 with a phone number “0123-456-789” (Step S331).

Because the calling destination is a phone number, in response to the request, the conferencing system server 2 informs the VoIP gateway 5 of the call from the client 3A to the phone 9 with the phone number “0123-456-789” (Step S332).

Responding to the information, the VoIP gateway 5 executes a PSTN call-control sequence for the phone 9 with the phone number “0123-456-789” (Step S333). Upon a response from the phone 9, the phone 9 is connected to the VoIP gateway 5 on the PSTN (Step S334).

The VoIP gateway 5 informs the client 3A of the response from the phone 9 with the phone number “0123-456-789”, and then connects to the client 3A (Step S335).

The client 3A and the phone 9 transmit/receive content data with each other via the VoIP gateway 5 (Step S336) to have a call (or conference).

Through the above processing, the client 3A and the phone 9 can conduct a conference with each other, despite being connected to different networks of an IP network and a PSTN.

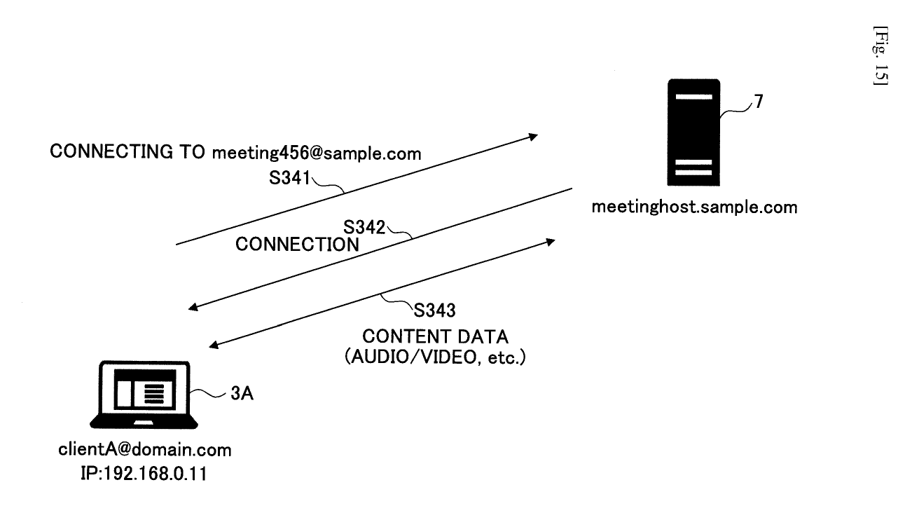

FIG. 15 is a drawing illustrating an example of processing performed at a time of connecting to the external internet conferencing system 7 through a P2P connection, where a P2P connection has been selected as the connection-method. In the above case, the client 3 and the external internet conferencing system 7 are connected through a P2P connection. Each of conferences provided by the external internet conferencing system 7 is assigned a conference ID in a SIP-URI format (cf. RFC3261). In the following description, the client 3A is assumed to conduct a conference ID.

In FIG. 15, as an example, the client 3A connects to “meetinghost.sample.com” in order to connect to a conference with a conference ID “meeting456 @ sample.com” (Step S341). In the example, it is assumed that a user knows that conducting a conference with “meeting456 @ sample.com” is possible through connecting to “meetinghost.sample.com”, although in general a user often searches a domain “sample.com” in a domain name system (DNS) of the external internet conferencing system 7, for reference to naming authority pointer resource records (NAPTR records) and service records (SRV records), in order to acquire an IP address, port, and protocol for connecting to a conference providing system.

Then, the external internet conferencing system 7 confirms that the conference with the conference ID “meeting456 @ sample.com” is connectable, and then sends a response of connection to the client 3A (Step S342).

The client 3A and the external internet conferencing system 7 transmit/receive content data with each other, to conduct a conference with other clients connected over the external internet conferencing system 7 (Step S343).

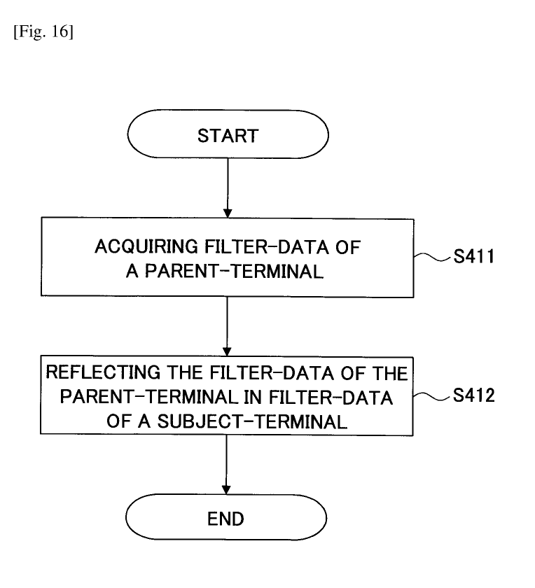

FIG. 16 is a flowchart illustrating an example of processing of updating the filter-data 310. In FIG. 16, the filter-data updating module 311 of a subject-terminal acquires filter-data from another client, which is preset as a parent-terminal, through processing performed in a case of being informed of an update of filter-data of the parent device or at a predetermined timing that is periodical or another type of timing (Step S411).

Then, the filter-data updating module 311 reflects the acquired filter-data in the filter-data 310 of the subject-terminal (Step S412). Here, in a case of not performing a self-initiated update of the filter-data 310 of the subject-terminal, the filter-data updating module 311 of the subject-terminal writes the filter-data acquired from the parent-terminal over the filter-data 310 of the subject-terminal. In a case of performing a self-initiated update of the filter-data 310 of the subject-terminal, the filter-data updating module 311 of the subject-terminal merges the filter-data acquired from the parent-terminal and the filter-data 310 of the subject-terminal for performing an update.

Through the above processing, maintenance performed on the filter-data of a client 3, which is preset as a parent-terminal, is reflected in the filter-data 310 of another client 3. Therefore, an amount of duplicated operations can be reduced.

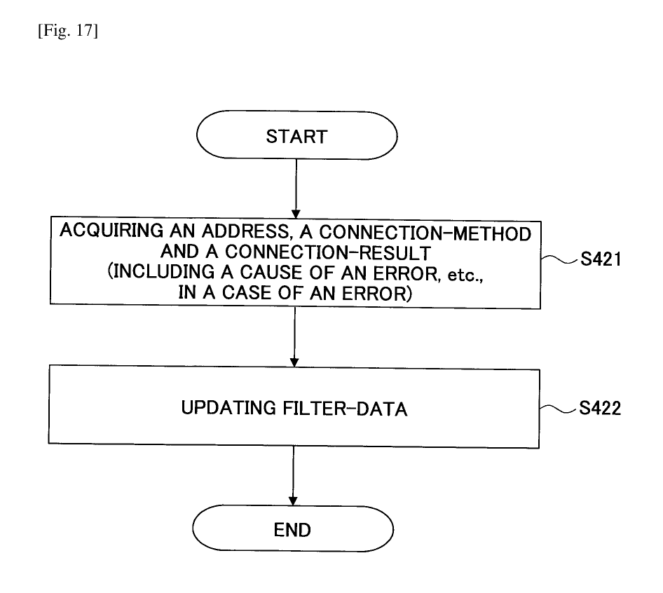

FIG. 17 is a flowchart illustrating another example of processing of updating the filter-data 310. In FIG. 17, the filter-data updating module 311 of a subject-terminal acquires a destination, a connection-method, and a connection-result, which correspond to each other, from the conference executing module 304, through processing that is performed every time connection for starting a conference is performed by the conference executing module 304 or at a predetermined timing that is periodical or another type of timing (Step S421).

Then, the filter-data updating module 311 of the subject-terminal updates the filter-data 310 of the subject-terminal, based on the acquired destination, connection-method, and connection-result (Step S422). For example, when a connection-method (i.e. a P2P connection or a C/S connection) and a connection-result (i.e. a success or an error) are obtained with respect to a destination whose connection-method is not se-lectable based on provided conditions of the filter-data 310, the filter-data updating module 311 adds new data to the filter-data 310. Furthermore, in a case where connection through a connection-method selected based on provided conditions of the filter-data 310 fails and where it is estimated that the error is caused by the connection-method (e.g. in a case where no other explicit cause is found, etc.), the filter-data updating module 311 modifies the filter-data 310.

Through the above processing, maintenance of the filter-data 310 is automatically performed during an ordinary use. Therefore, an amount of maintenance operations can be reduced.

### CONCLUSION

As explained above, in a case where a network conferencing system is compatible with multiple connection-methods, the embodiment of the present invention reduces complexity of switching connection-methods to one that is compatible with a counterpart-terminal to connect with.

The above description explains the present invention along with a preferable embodiment of the present invention. It should be noted that, although the above description explains the present invention along with specific examples, variations and modifications to the specific examples may be made without departing from the broad intent and scope of the claimed present invention. In other words, the present invention should not be interpreted as being limited to description of the specific examples nor the accompanied drawings.

### Correspondence of Terms in the Embodiment and in the Claims

The user-interface module 301 is an example of a module configured to receive an input indicating a destination of a call. The call-condition filter 309 is an example of a module configured to refer to filter-data in order to determine whether the destination matches the filter-data. The filter-data 310 is an example of filter-data. The conference executing module 304 and the filter-data 310 are examples of a module configured to select one of the plurality of connection-methods.

The filter-data updating module 311 is an example of a module configured to acquire said another filter-data and a module configured to reflect said another filter-data in the filter-data. The filter-data updating module 311 is an example of a module configured to acquire a destination, a connection-method, and a connection-result and a module configured to update the filter-data.

The present application is based on Japanese priority application No. 2016-090219 filed on Apr. 28, 2016, with the Japanese Patent Office, the entire content of which is hereby incorporated by reference.

### REFERENCE SIGNS LIST

1 intranet
2 conferencing system server
21 authentication module
22 client-information storing module
23 communication module
24 conference managing module
25 conference-information storing module
3, 3A, 3B, 3C client
301 user-interface module
302 authentication requesting module
303 communication module
304 conference executing module
305 video display module
306 audio reproducing module
307 video importing module
308 audio importing module
309 call-condition filter
310 filter-data
311 filter-data updating module
4 firewall
5 VoIP gateway
6 internet
7 external internet conferencing system
8 PSTN 8
9 phone 9

1. A network conferencing system that is compatible with a plurality of connection-methods, the network conferencing system comprising:
a module configured to receive an input indicating a destination of a call;
a module configured to refer to filter-data, which is preset in a predetermined format, in order to determine whether the destination matches the filter-data; and
a module configured to select one of the plurality of connection-methods, based on whether the destination matches the filter-data.

2. The network conferencing system according to claim 1, wherein the plurality of connection-methods include a peer-to-peer connection and a client-server model connection.

3. The network conferencing system according to claim 1,
wherein the filter-data includes one of one or more phone numbers, one or more SIP addresses, and one or more SIP domains, and
wherein the filter-data corresponds to a matching-method, which is used in determining whether the destination matches the filter-data, and to one of the plurality of connection-methods, which is to be selected in response to determining that the destination matches the filter-data.

4. The network conferencing system according to claim 3, wherein the matching-method is one of a front-match method, an exact-match method, and a method by use of a regular expression.

5. The network conferencing system according to claim 1,
wherein the network conferencing system includes a subject-terminal and a predetermined parent-terminal, and
wherein the filter-data is stored in the subject-terminal and another filter-data is stored in the parent-terminal, the network conferencing system further comprising:
a module configured to acquire said another filter-data from the parent-terminal; and
a module configured to reflect said another filter-data acquired from the parent-terminal in the filter-data stored in the subject-terminal.

6. The network conferencing system according to claim 1, further comprising:
a module configured to acquire a destination, a connection-method, and a connection-result, which correspond to each other, from a module configured to execute connection; and
a module configured to update the filter-data stored in a subject-terminal, based on the acquired destination, connection-method and connection-result.

7. A terminal connectable to a network conferencing system that is compatible with a plurality of connection-methods, the terminal comprising:
a module configured to receive an input indicating a destination of a call;
a module configured to refer to filter-data, which is preset in a predetermined format, in order to determine whether the destination matches the filter-data; and
a module configured to select one of the plurality of connection-methods, based on whether the destination matches the filter-data.

8. A non-transitory computer-readable recording medium storing a program for causing a computer included in a terminal to execute a process, the terminal being connectable to a network conferencing system that is compatible with a plurality of connection-methods, the process comprising:
receiving an input indicating a destination of a call;
referring to filter-data, which is preset in a predetermined format, in order to determine whether the destination matches the filter-data; and
selecting one of the plurality of connection-methods, based on whether the destination matches the filter-data.

9. A method performed by a terminal connectable to a network conferencing system that is compatible with a plurality of connection-methods, the method comprising:
receiving an input indicating a destination of a call;
referring to filter-data, which is preset in a predetermined format, in order to determine whether the destination matches the filter-data; and
selecting one of the plurality of connection-methods, based on whether the destination matches the filter-data.
